(19) United States
(12) Patent Application Publication
(10) Pub. No.: US 2009/0282455 A1
(43) Pub. Date: Nov. 12, 2009

(54) Portable Tester for Set-Top Box

(75) Inventors: Douglas J. Bell, Marina Del Ray, CA (US); William R. Ryan, Greater Manchester (GB)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: PACE MICRO TECHNOLOGY, PLC, West Yorkshire (GB)

(21) Appl. No.: 12/115,898

(22) Filed: May 6, 2008

(51) Int. Cl. H04N 7/16

(52) U.S. Cl. 725/151

(57) ABSTRACT

A portable tester includes a housing sized to be handheld and adapted to enclose a processor and a non-volatile memory, a communication port adapted to couple a link with a set-top box and a communications port adapted to couple a link with an external computer, and an input/output (I/O) device, non-volatile memory comprising a test initiation application that sends test initiation commands through the communication port over the link to a testing application residing in the multimedia device, non-volatile memory receiving data generated by execution of the testing application and storing the data in non-volatile memory, non-volatile memory further comprising a data download application that sends the stored data through the communication port over the link to the external computer.

### FIELD OF THE TECHNOLOGY

At least some embodiments disclosed herein relate to a portable tester for a set-top box.

### BACKGROUND

Consumers are beginning to have access to a large number of television programs over an increasing number of television channels. Set-top boxes (STBs) such as satellite receivers, cable boxes, and digital video recorders or combinations thereof are becoming more popular because they provide features to consumers that were not previously available. STBs, for example, enable users to digitally record programming content such as television programs, lock certain channels from being accessed without permission, view electronic program guide data, and set personal preferences that control how the program guide data and/or the programming content is presented to the user.

More particularly, a STB or set-top unit (STU) is a device that connects to a television and an external source of a signal, turning the signal into content which is then displayed on the television (TV) or monitor screen. The external signal source can be an Ethernet cable, a satellite dish, a coaxial cable, a telephone line (including Digital Subscriber Line (DSL) connections), Broadband over Power Line, or a Very High Frequency (VHF) or Ultra High Frequency (UHF) antenna. Content in this context can refer to any or all of video, audio, Internet web pages, interactive games, and so forth.

STB functions have been advancing from one generation to the next. Picture quality has also been enhanced by the availability of high-density (HD) content. In recent years, broadcast applications through Internet Protocol (IP) have driven the need for new compression technologies, such as H.264 (i.e., MPEG-4 Part 10) and VC-1 (i.e., the SMPTE 421M video codec standard initially developed by Microsoft).

STBs, as part of a video delivery system, can experience faults and failures for a variety of reasons. Customer expectations, however, center on system “up-time” and the quality from a STB.

### SUMMARY OF THE DESCRIPTION

Systems and methods for a portable tester for a set-top box. Some embodiments are summarized in this section.

In one aspect, the invention features a portable set-top box tester including a housing adapted to enclose a processor and a non-volatile memory, a communication port adapted to couple a link with a multimedia device and a communication port adapted to couple a link with an external computer, and an input/output (I/O) device, non-volatile memory comprising a test initiation application that sends test initiation commands through the communication port over the link to a testing application residing in the multimedia device, non-volatile memory receiving data generated by execution of the testing application and storing the data in non-volatile memory.

In another aspect, the invention features a portable tester including a housing sized to be handheld and adapted to enclose a processor and a non-volatile memory, a communication port adapted to couple a link with a set-top box and a communications port adapted to couple a link with an external computer, and an input/output (I/O) device, non-volatile memory comprising a test initiation application that sends test initiation commands through the communication port over the link to a testing application residing in the multimedia device, non-volatile memory receiving data generated by execution of the testing application and storing the data in non-volatile memory, non-volatile memory further comprising a data download application that sends the stored data through the communication port over the link to the external computer.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 is a block diagram of an exemplary content network.

FIG. 2 is a block diagram of an exemplary portable set-top box tester.

FIG. 3 is a flow diagram.

### DETAILED DESCRIPTION

The following description and drawings are illustrative and are not to be construed as limiting. Numerous specific details are described to provide a thorough understanding. However, in certain instances, conventional details are not described in order to avoid obscuring the description. References to one or an embodiment in the present disclosure are not necessarily references to the same embodiment; and, such references mean at least one.

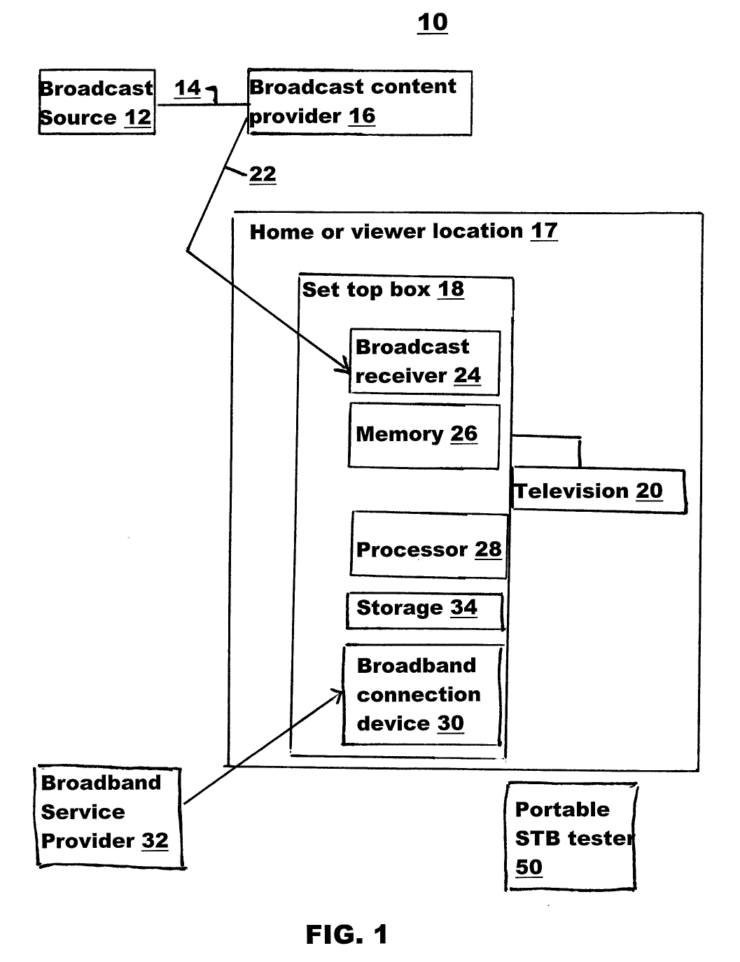

As shown in FIG. 1, an exemplary content network 10 includes a broadcast source (e.g., television station) 12 that sends content over a communications channel 14 to a broadcast content provider (e.g., cable provider, satellite provider, and so forth) 16. A home or viewer location 17 contains a set-top box (STB) 18 that provides a video input to a television 20. The STB 18 receives broadcast content from broadcast content provider 16 over a communication channel 22.

STB 18 can include several components. A broadcast receiver 24 enables the STB 20 to receive programming transmitted from broadcast content provider 16, and may be for example, a direct broadcast satellite (DBS) receiver, cable receiver, or the like. Memory 26 stores input data, such as data identifying the viewing characteristics of a viewer. Processor 28 enables the STB 18 to gather input data such as data identifying the viewing characteristics of the operator. In some examples, the STB 18 includes a broadband connection device 30 that provides connectivity to a broadband data network 32 and may be, for example, a modem device for communication over a digital subscriber line (DSL) or cable modem connection. Other architectures exist, such as, for example, a receiver integrated into a processor using broadband as a source.

STB 18 can include a storage device 34, such as a disk drive, CD drive, and so forth. Content viewed through the STB 18 may be stored on the storage device 34.

Although not shown, the STB 18 can include one or more connectors, such as, for example, a SCART socket, a HDMI connector for coupling to a high-definition TV (HDTV), a TV aerial RF co-ax aerial input, a TV aerial RF co-ax aerial output, an Ethernet RJ45 socket, a USB socket, stereo audio phono outputs, S/PDIF optical audio out socket, S-Video socket and/or RJ11 Phone line socket.

Memory 26 can include middleware, platform details, and applications. Middleware typically includes an application manager, a virtual machine (such as Java Virtual Machine™), an interactive engine, libraries and databases. If the STB has a resident application, it's often thought of as middleware. In this case, a resident application is a program or programs that are built into memory 26. These are updated, often automatically, by the network operator via the data stream (signal) that the set-top box receives from the network operator.

The platform generally refers to the content provider's or communications transmission system, such as digital terrestrial (e.g., multichannel multiport distribution system (MMDS)), cable, telco, satellite, and the Internet.

Applications can include specialized test software that when initiated by a trained technician, can perform tests on the STB 18, such as tests on the memory 26, broadcast receiver 24, processor 28, broadband connection device 30, and the one or more connectors described above. Test software is initiated by a trained test technician and not a home user or viewer. Example test software is Testtask from Pace Micro Technology PLC. Testtask, and other such applications, is considered to be a lower level application, which functions in conjunction with a higher level interface or front end, which may or may not reside in the STB.

Problems can occur within the home or viewer location 17. When a problem occurs, the user will typically contact the broadcast content provider 16, who will speak directly to the user or dispatch a technician to the site. During this customer service contact between the user and the broadcast content provider 16 or technician, the STB is looked at and more often than not, the broadcast content provider 16 or technician instructs the user to send the set-top box 18 to a repair center. This shipping and handling of the set-top box 18 to and from a repair center leads to a larger cost of ownership.

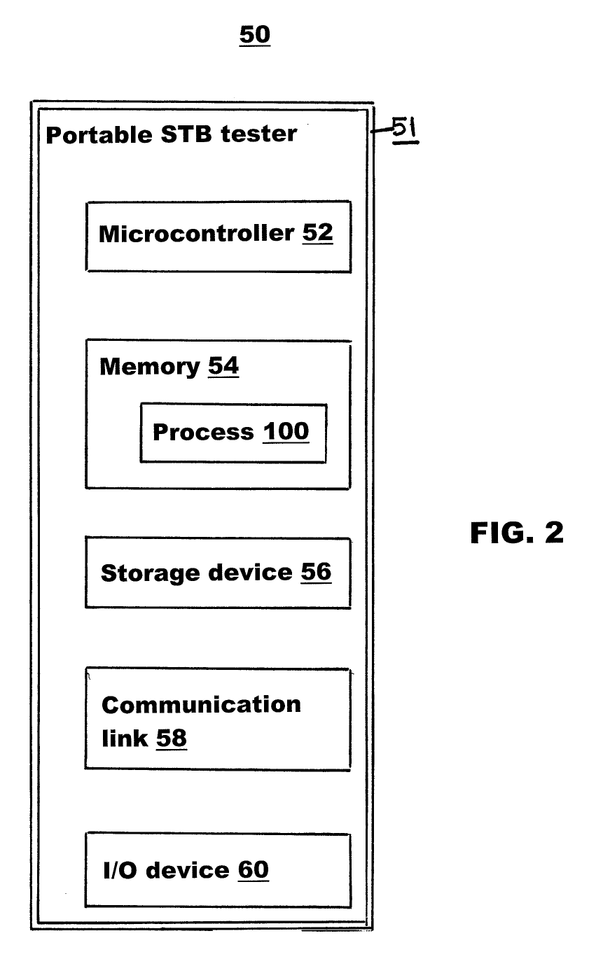

In order to decrease the number of set-top boxes that are returned to repair centers that are not faulty, in-situ testing by a field technician is preferred. The field technician performs such tests at the user's home or viewing location 17 using a portable set-top box tester 50, and described below with reference to FIG. 2.

As shown in FIG. 2, the exemplary portable set-top box tester 50 includes a housing 51 enclosing a processor 52, non-volatile memory 54, storage device 56, communication link 58, and input/output (I/O) device 60. Non-volatile memory 54 includes a test initiation application 100, described below.

Example communication links 58 include a coaxial cable port, a Universal Serial Bus (USB) port, Ethernet port, a RS-232 connector, and so forth. The communication link 58 may include an Application Programming Interface (API). In general, an API is a source code interface that an operating system or library provides to support requests for services to be made of it by computer programs. The I/O device 60 can include a display and input mechanism, such as one or more keys and a video screen.

The portable set-top box tester 50 is used by a trained field technician to perform in-home testing of a set-top box, such as the set-top box 18. The portable set-top box tester 50 is attached by the field technician to the set-top box 18 using a communication line connecting the communication link 58 with one of the connectors on the set-top box 18. Once connected, the field technician can execute the test initiation application 100, which communicates with test software executing resident in the set-top box 18. The test initiation application 100 sends a test initiation command or commands and causes the test software resident in the set-top box 18 to initiate and execute various tests, such as, to exercise hardware functions in the set-top box 18 and so forth. The results of these tests are sent back to the portable set-top box tester 50 and stored for analysis in non-volatile memory 54 and/or the storage device 56. The tests executed in the set-top box 18 can include testing hardware in ways not possible using the set-top box's normal interfaces, including buttons, indicators, connectors, and visual screens.

The results may in part be based on field technician feedback. For example, the field technician may need to respond “yes” or “no” when prompted on the technician's I/O device whether the technician sees LEDs on the STB properly lit. The portable set-top box tester 50 records the results until uploaded to a computer system at a later time for analysis and/or diagnosis.

Non-volatile memory 54 can also include test applications for analysis or generation of other signals, such as satellite feeds, cable feeds, Ethernet or other signals encountered in a set-top box environment. Non-volatile memory 54 can also include test applications that perform functions on the set-top box 18 that are not typically considered to be tests, such as, the downloading of files or erasing nonvolatile storage on the set-top box 18.

The portable set-top box tester 50 achieves the goal of reliable in situ diagnosis by combining a portable tester having nonvolatile storage with software resident on the set-top box 18 capable of running a multitude of tasks. Test software residing in the set-top box 18 can exercise numerous functions within the set-top box 18, including modem, flash, version numbers, product identification numbers, memory, audio, serialization, smartcard, Ethernet, hard drive, temperature, USB, test patterns, and so forth. Results of these tests stored in the portable set-top box tester 50 can then be communicated over an interface, such as a USB link, to a computer system, which analyzes of the data.

The portable set-top box tester 50 can include applications to measure or test the set-top box's environment, such as satellite feeds signal quality or phone line connection. These features enable the field technician to pinpoint items other than set-top box internals that can affect set-top box operation, and might otherwise result in unnecessary set-top box replacement.

In other specific examples, the portable set-top tester 50 can include a modem, cellular device or Bluetooth technology, enabling the transmission of stored test results to be transmitted to a diagnostic computer.

Among its many advantages, a manufacturer of a set-top box can receive specific data on field tests and rely on these tests rather than on arbitrary and hand written feedback. This can also insure that field technicians actually worked on the set-top box in an appropriate way. Stored test data, as described above, can eventually be sent to a central repository for further analysis and/or historical analysis.

Another advantage of the portable set-top box tester 50 is at the same communication link used to connect the portable set-top box tester 50 the set-top box 18 can be used to connect the portable set-top box tester 50 to a computer in order to analyze and diagnose using stored data.

Because the portable set-top box tester 50 is portable, and in some instances, ruggedized, it is quite suitable for use by field technicians. Usage of the portable set-top box tester 50 is less expensive than relying on PC-based test solutions at a repair center. The portable set-top box tester 50 is suitable for accessing certain tests or other procedures that would be undesirable to have exposed to certain parties, whether it be an end user or an untrained test person.

The portable Set-top box tester 50 has intelligence to initiate various tests and can use various configuration scripts to implement product-specific sequences of tests in the STB 18. Such configuration scripts can be invoked upon a response to a product ID query and also on a board revision basis. In one example, a special script is invoked for a certain range of serial numbers known to exhibit some anomaly.

The portable Set-top box tester 50 can include logic for “on-the-fly” decisions to run specific tests as well, such as, for example, if a set-top box 18 failed to tune, various further tests could be run (e.g. internal bus tests) to attempt to isolate the fault.

The portable Set-top box tester 50 can include facilities for diagnosis and repair of configuration data stored on the set-top box 18, such as identifying setup info stored in electrically erasable programmable read-only memory (EEPROM) that might be discerned as corrupted.

The portable Set-top box tester 50 can initiate a test that takes a long period of time to run in the background (e.g., a hard drive scan) and then proceed to run other tests while awaiting results from the long test.

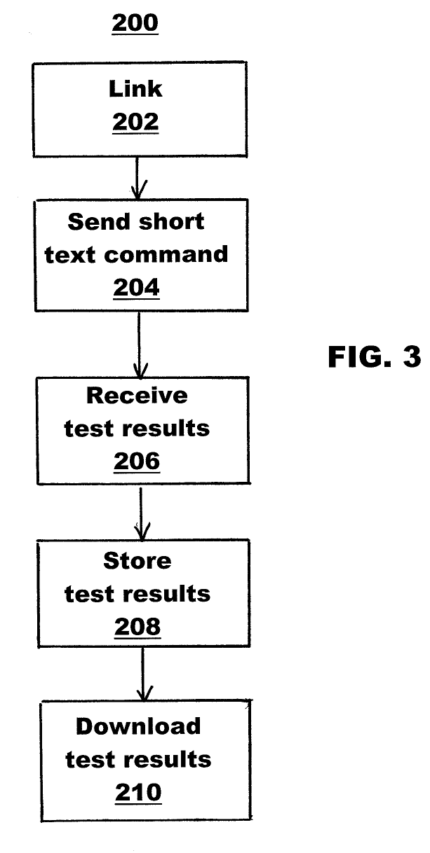

As shown in FIG. 3, a process 200 includes linking (202) a portable set-top box tester to a set-top box. Linking (202) can include a physical cable connecting a USB port of the portable set-top box tester to the set-top box, an Ethernet cable connecting an Ethernet port of the portable set-top box tester to the set-top box, a coaxial cable, and so forth. Process 200 sends (204) a start test command from the portable set-top box tester to the set-top box, wherein test software resident in the set-top box executes and generates data by testing functions within the set-top box. Process 200 receives (206) the generated test data from the test software executing in the set-top box and stores (208) the generated data in non-volatile memory of the portable set-top box tester. Receiving (206) may prompt a user for input. Process 200 downloads (210) the stored data in non-volatile memory to a computer system for analysis and/or permanent storage. Downloading (210) can include a physical cable, such as a USB cable, Ethernet cable, a coaxial cable, and so forth. Downloading (210) can also include wirelessly transferring the stored data to the computer system using a modem, cellular device, Bluetooth technology, and so forth.

In this description, various functions and operations may be described as being performed by or caused by software code to simplify description. However, those trained in the art will recognize what is meant by such expressions is that the functions result from execution of the code by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A portable set-top box tester comprising:
a housing adapted to enclose a processor and a non-volatile memory, a communication port adapted to couple a link with a multimedia device and a communication port adapted to couple a link with an external computer, and an input/output (I/O) device, non-volatile memory comprising a test initiation application that sends test initiation commands through the communication port over the link to a testing application residing in the multimedia device, non-volatile memory receiving data generated by execution of the testing application and storing the data in non-volatile memory.

2. The portable set-top box tester of claim 1 wherein the multimedia device is a set-top box (STB).

3. The portable set-top box tester of claim 1 wherein the communication port is one of a Universal Serial Bus (USB) port, a coaxial cable port, a RS-232 port or an Ethernet port.

4. The portable set-top box tester of claim 1 wherein the link is one of a USB cable, a coaxial cable, a RS-232 cable or an Ethernet cable.

5. The portable set-top box tester of claim 1 where the testing application exercises hardware functions of the multimedia device.

5A. The portable set-top box tester of claim 1 wherein the testing application prompts a user for input used to generate data.

6. The portable set-top box tester of claim 5 wherein hardware functions include one or more of modem, flash non-volatile memory, version number, USB ports, product identification number, non-volatile memory, audio, front panel functions, serialization, smartcard, Ethernet port, hard drive and temperature.

7. The portable set-top box tester of claim 1 wherein test initiation application is adapted to send input parameters through the I/O device to the testing application residing in the multimedia device.

8. The portable set-top box tester of claim 1 test initiation application is adapted to send commands to the multimedia device to test the multimedia device's environment.

9. The portable set-top box tester of claim 1 wherein non-volatile memory further comprises a data download application that sends the stored data through the communication port over the link to the external computer system.

10. The portable set-top box tester of claim 9 wherein the microprocessor is linked to a communications device for transmitting stored data to the extended computer.

11. The portable set-top box tester of claim 10 wherein the communications device is one of a modem, a cellular device or a Bluetooth module.

12. The portable set-top box tester of claim 1 wherein the housing is sized to be handheld and is fabricated from a plastic.

13. A portable tester comprising:
a housing sized to be handheld and adapted to enclose a processor and a non-volatile memory, a communication port adapted to couple a link with a set-top box and a communications port adapted to couple a link with an external computer, and an input/output (I/O) device, non-volatile memory comprising a test initiation application that sends test initiation commands through the communication port over the link to a testing application residing in the multimedia device, non-volatile memory receiving data generated by execution of the testing application and storing the data in non-volatile memory, non-volatile memory further comprising a data download application that sends the stored data through the communication port over the link to the external computer.

14. The portable tester of claim 13 wherein the communication port is one of a Universal Serial Bus (USB) port, a coaxial cable port, a RS-232 port or an Ethernet port.

15. The portable tester of claim 13 wherein the link is one of a USB cable, a coaxial cable, a RS-232 cable or an Ethernet cable.

16. The portable tester of claim 13 where the testing application exercises hardware functions of the set-top box.

16A. The portable set-top box tester of claim 13 wherein the testing application prompts a user for input used to generate data.

17. The portable tester of claim 16 wherein hardware functions include one or more of modem, flash non-volatile memory, version number, USB ports, product identification number, non-volatile memory, audio, front panel functions, serialization, smartcard, Ethernet port, hard drive and temperature.

18. The portable tester of claim 13 wherein test initiation application is adapted to send input parameters through the I/O device to the testing application residing in the set-top box.

19. The portable tester of claim 13 wherein the microprocessor is linked to a communications device for transmitting stored data to the external computer.

20. The portable tester of claim 19 wherein the communications device is one of a modem, a cellular device or a Bluetooth module.
